(19) United States
(12) Patent Application Publication
(10) Pub. No.: US 2005/0216758 A1
(43) Pub. Date: Sep. 29, 2005

(54) Frame authentication for a wireless network

(76) Inventors: Pawel Oskar Matusz, Rumia (PL); Krzysztof Jacek Kaminski, Gdynia (PL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/809,607

(22) Filed: Mar. 24, 2004

(51) Int. Cl. H04L 9/00

(52) U.S. Cl. 713/200

(57) ABSTRACT

Method and apparatus to perform frame authentication for a wireless network are described.

### BACKGROUND

A communications network may be configured to communicate frames of information between different devices. A network may be compromised when a person attempts to communicate unauthorized frames to a network device. For example, a “denial of service” attack may involve sending a relatively large number of unauthorized frames to a network device. Such security threats may disrupt network services or otherwise cause undesirable network behavior. Consequently, there may be a need for techniques to reduce such security threats in a device or network.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a block diagram of a system 100 in accordance with one embodiment;

FIG. 2 illustrates a block diagram of a system 200 in accordance with one embodiment;

FIG. 3 illustrates a frame 300 in accordance with one embodiment;

FIG. 4 illustrates a block diagram of a system 400 in accordance with one embodiment;

FIG. 5 illustrates a block flow diagram for a processing logic 500 in accordance with one embodiment; and

FIG. 6 illustrates a block diagram for a system 600 in accordance with one embodiment.

### DESCRIPTION OF SPECIFIC EMBODIMENTS

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

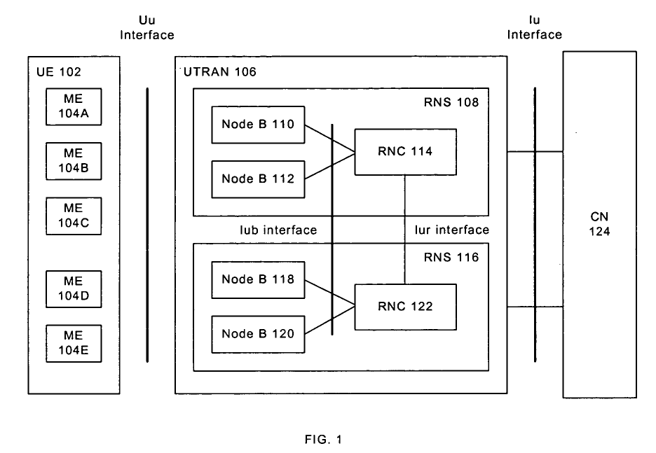

Referring now in detail to the drawings wherein like parts are designated by like reference numerals throughout, there is illustrated in FIG. 1 a system suitable for practicing one embodiment. FIG. 1 is a block diagram of a system 100. System 100 may comprise a plurality of nodes. The term “node” as used herein may refer any element, module, component, board, device or system that may process a signal representing information. The signal may be, for example, an electrical signal, optical signal, acoustical signal, chemical signal, and so forth. The embodiments are not limited in this context.

System 100 may comprise a plurality of nodes connected by varying types of communications media. The term “communications media” as used herein may refer to any medium capable of carrying information signals. Examples of communications media may include metal leads, semiconductor material, twisted-pair wire, co-axial cable, fiber optic, radio frequency (RF) spectrum, and so forth. The terms “connection” or “interconnection,” and variations thereof, in this context may refer to physical connections and/or logical connections. The nodes may connect to the communications media using one or more input/output (I/O) adapters, such as a network interface card (NIC), for example. An I/O adapter may be configured to operate with any suitable technique for controlling communication signals between computer or network devices using a desired set of communications protocols, services and operating procedures, for example. The I/O adapter may also include the appropriate physical connectors to connect the I/O adapter with a suitable communications medium.

In one embodiment, for example, system 100 may be implemented as a wireless system having a plurality of nodes using RF spectrum to communicate information, such as a cellular or mobile system. In this case, one or more nodes shown in system 100 may further comprise the appropriate devices and interfaces to communicate information signals over the designated RF spectrum. Examples of such devices and interfaces may include omni-directional antennas and wireless RF transceivers. The embodiments are not limited in this context.

The nodes of system 100 may be configured to communicate different types of information. For example, one type of information may comprise “media information.” Media information may refer to any data representing content meant for a user, such as data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Another type of information may comprise “control information.” Control information may refer to any data representing commands, instructions or control words meant for an automated system. For example, control information may be used to route media information through a system, or instruct a node to process the media information in a predetermined manner. The embodiments are not limited in this context.

In one embodiment, system 100 may comprise a wireless system, such as a Universal Mobile Telecommunication System (UMTS) network. UMTS network 100 may be configured to operate in accordance with the Third-Generation Partnership Project (3GPP) 3G TS line of specifications. In one embodiment, for example, UMTS network 100 may comprise various network nodes, such as user equipment (UE) 102, a UMTS terrestrial radio access network (UTRAN) 106, and a core network (CN) 124. Although FIG. 1 shows a limited number of nodes, it can be appreciated that any number of nodes in various topologies may be used in system 100. Further, although the embodiments may be illustrated in the context of a wireless communications system, the principles discussed herein may also be implemented in a wired communications system as well. The embodiments are not limited in this context.

In one embodiment, UMTS network 100 may comprise UE 102. UE 102 may comprise a plurality of mobile equipment (ME) 104A-E. ME 104A-E may comprise a number of different wireless nodes, such as mobile or cellular telephone, a computer equipped with a wireless access card or modem, a handheld client device such as a wireless personal digital assistant (PDA), and so forth. The number and type of ME are not limited in this context.

In one embodiment, UMTS network 100 may comprise UTRAN 106. UTRAN 106 may be configured to handle the air interface or radio-related functionality for UMTS network 100. In one embodiment, for example, UTRAN 106 may comprise a radio network sub-system (RNS) 108 and a RNS 116. Each RNS may comprise a RNC and one or more Node B systems. For example, RNS 108 may comprise a RNC 114 connected to Node B 110 and Node B 112. Similarly, RNS 116 may comprise a RNC 122 connected to a Node B 118 and Node B 120.

In one embodiment, UMTS network 100 may comprise CN 124. CN 124 may be responsible for switching and routing calls and data connections to external networks. For example, CN 124 may include connections to the Public Switched Telephone Network (PSTN), the Internet, a private or corporate network, and so forth. CN 124 may accomplish this using various other network nodes, such as a mobile services switching center (MSC), a visitor location register (VLR), gateway MSC (GMSC), serving GPRS support node (SGSN), gateway GPRS support node (GGSN), and so forth. The embodiments are not limited in this context.

The various elements of UMTS network 100 may communicate media or control information in accordance with one or more communication protocols. The term “protocol” as used herein may refer to a set of instructions to control how the information is communicated over the communications medium. The protocols may be implemented as part of a network interface, such as a network adapter as previously described. In one embodiment, for example, UE 102 and UTRAN 106 may communicate information in accordance with one or more “Uu interface” protocols, such as the 3GPP specification titled “Radio Resource Control (RRC) Protocol Specification,” 3G TS 25-331, release 1999 (“Uu Specification”). In another example, Node B systems 110, 112, 118 and 120 may communicate with RNC 114 and/or RNC 122 in accordance with one or more “Iub interface” protocols, such as the 3GPP specification titled “UTRAN Iub Interface: General Aspects and Principles,” 3G TS 25-430, release 1999 (“Iub Specification”). In yet another example, RNC 114 and RNC 122 may communicate information with each other in accordance with one or more “Iur interface” protocols, such as the 3GPP specification titled “UTRAN Iur Interface: General Aspects and Principles,” 3G TS 25-420, release 1999 (“Iur Specification”). In yet another example, UTRAN 106 may communicate information with CN 124 in accordance with one or more “Iu interface” protocols, such as the 3GPP specification titled “UTRAN Iu Interface: General Aspects and Principles,” 3G TS 25-410, release 1999 (“Iu Specification”). The type and number of protocols may vary according to a given implementation. The embodiments are not limited in this context.

In general operation, UMTS network 100 may operate to communicate media and control information between a pair of end points, such as ME 104A and ME 104E or a wired device, for example. One or more elements of UMTS network 100 may comprise part of a signaling flow to manage a call connection between the end points. The signaling flow may be used to communicate control information to setup the call connection, perform hand off operations as a ME passes from one cell to another, tear down a call connection, and so forth. One or more elements of UMTS network 100 may comprise part of a data flow to communicate media information between the end points, such as the content of a telephone call, for example.

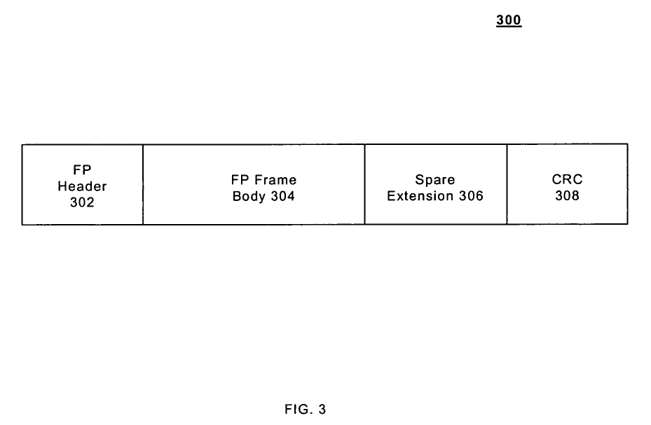

Both the signaling flow and data flow may communicate information in the form of packets, packet data units (PDU) or frames (collectively referred to hereinafter as “frame”). A frame may comprise a discrete number of bits or bytes, organized in one or more fields. Frame size may vary in accordance with the given protocol and network interface used to implement the protocol. A sample frame may be discussed in more detail with reference to FIG. 3.

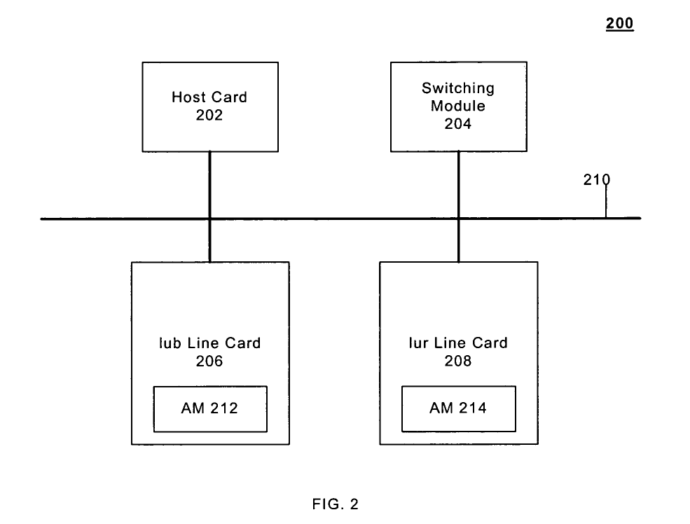

FIG. 2 illustrates a block diagram of a system 200 in accordance with one embodiment. System 200 may be an RNC representative of, for example, RNC 114 and/or RNC 122. As shown in FIG. 2, system 200 may comprise a host card 202, an Ethernet switching module 204, an Iub line card 206, and an Iur line card 208, all connected via a high-speed Ethernet backplane 210. Line cards 206 and 208 may further comprise authentication module (AM) 212 and AM 214, respectively. Although FIG. 2 shows a limited number of modules, it can be appreciated that any number of modules may be used in RNC 200.

In one embodiment, RNC 200 may comprise host card 202. Host card 202 may comprise a processing system configured to manage RNC 200, as well as execute various RNC applications and signaling protocols. The processing system may comprise, for example, a processor, program instructions, and memory. The processor could be a general purpose processor made by Intel Corporation, or a dedicated processor such as a digital signal processor (DSP), network processor, embedded processor, micro-controller, controller, input/output (I/O) processor (IOP), and so forth. The memory may comprise machine-readable media and accompanying memory controllers or interfaces. The machine-readable media may include any media capable of storing instructions and data adapted to be executed by the processor. Some examples of such media include, but are not limited to, read-only memory (ROM), random-access memory (RAM), programmable ROM, erasable programmable ROM, electronically erasable programmable ROM, dynamic RAM, double data rate (DDR) memory, dynamic RAM (DRAM), synchronous DRAM (SDRAM), embedded flash memory, and any other media that may store digital information. The embodiments are not limited in this context.

In one embodiment, RNC 200 may comprise switching module 204. Ethernet switching module 204 may be configured to switch frames of information between host card 202, line card 206, and line card 208, via high-speed Ethernet back plane 210. Ethernet back plane 210 may be any type of back plane, such as a cross-bar switch, communications fabric, communications mesh, and so forth. The embodiments are not limited in this context.

In one embodiment, RNC 200 may comprise one or more network interfaces, such as Iub line card 206 and Iur line card 208. Iub line card 206 may process the Iub interface traffic in accordance with the lub Specification. The Iub interface traffic may comprise, for example, frames communicated between Node B systems 110/112 and RNC 114, or Node B systems 118/120 and RNC 122, respectively. Iur line card 208 may process Iur interface traffic in accordance with the Iur Specification. Iur interface traffic may comprise, for example, frames communicated between RNC 114 and RNC 122. It may be appreciated that RNC 200 may also be configured with other network interfaces in accordance with a given implementation. For example, RNC 200 may also be configured with an Iu line card to process Iu interface traffic in accordance with the Iu Specification. The type and number of network interfaces are not limited in this context.

In general operation, system 200 may operate to communicate frames of information between UE 102 and/or CN 124 via the appropriate network interfaces. For example, a frame of information from ME 104A may be received by node B 110 via the Uu interface over the RF wireless medium. Node B 110 may communicate the frame to RNC 114 via the Iub interface. RNC 114 may receive the frame at Iub line card 206. Iub line card 206 may determine that the end point for the frame is ME 104E. This determination may be made using information from host card 202, for example. Consequently, Ethernet switching module 204 may switch the frame from Iub line card 206 to Iur line card 208 via backplane 210. RNC 114 may communicate the frame to RNC 122, to be communicated down stream to ME 104E.

As previously stated, one type of problem associated with UMTS network 100 and RNC 200 may comprise security threats. UMTS network 100 may be compromised if a person attempts to communicate unauthorized frames to an element of UMTS network 100. For example, a “hacker” may attempt to initiate a denial of service attack by flooding RNC 200 with unauthorized frames. This may disrupt the operation of UMTS network 100 or otherwise cause undesirable network behavior.

To solve these and other problems, line cards 206 and 208 may be configured with authentication modules, such as AM 212 and AM 214, respectively. AM 212 and AM 214 may be configured to authenticate frames of information. For example, AM 212 may be configured to authenticate frames of information received from a node B system, such as Node B systems 110, 112, 118 and 120. In another example, AM 214 may be configured to authenticate frames of information received from a RNC, such as RNC 114 or 122. If a frame is not properly authenticated, it may be assumed a security threat and dropped from the network. The authentication modules may be discussed in more detail with reference to FIGS. 3-6.

In one embodiment, one or more portions of RNC 200 (e.g., host 202, Iub line card 206, Iur line card 208) may be implemented using a network processor. For example, the network processor may be an Internet Exchange Architecture (IXA) network processor made by Intel Corporation, such as an Intel IXP 2800. The network processor may contain multiple processing elements, such as multiple microengines and a processor core. The processing core may be, for example, an Intel StrongARM® Core (ARM is a trademark of ARM Limited, United Kingdom). The processor core may also include a central controller that assists in loading code for other resources of the network processor, for example, and performs other general-purpose computer type functions such as handling protocols, exceptions and extra support for packet processing. The microengines may include memory that may have the capability to store instructions, for example. For example, in one embodiment there may be sixteen microengines, with each microengine having the capability to process eight program threads. The embodiments are not limited in this context.

FIG. 3 illustrates a frame 300 in accordance with one embodiment. Frame 300 may comprise a frame used to communicate information in accordance with a protocol for systems 100 and/or 200, such as a framing protocol (FP), for example. In one embodiment, frame 300 may comprise a FP header field 302, a FP frame body field 304, a spare extension field 306, and a cyclical redundancy check (CRC) field 308. Although frame 300 illustrates a number of different fields, it may be appreciated that frame 300 may comprise more or less fields and still fall within the scope of the embodiments.

A FP may be a UMTS protocol used to frame channels supported by various network interfaces, such as the Iur interface, Iub interface, and so forth. The FP may comprise a user plane protocol and forms Layer-1 of the radio network layer of access stratum in a UMTS network, such as UMTS network 100. The FP provides a synchronization function between higher-layer radio access protocols (e.g., Radio Link Control and Media Access Control) and the timing requirements of the radio transmission system. On the Iur and Iub interfaces, for example, the FP may be used for uplink and downlink data transfer. The FP for a dedicated channel enables the RNC to exchange user data frames with UE serviced by its own Node B system as well as remote Node B systems. The FP is also capable of performing certain control functions like timing adjustment and synchronization. Updates to the radio parameters can also be done through the FP. The FP for common transport on the Iur interface may handle flow control to a RNC, and on the Iub interface the FP may handle synchronization and timing adjustment apart from data transfer between a Node B and RNC for Iub-common channel, for example.

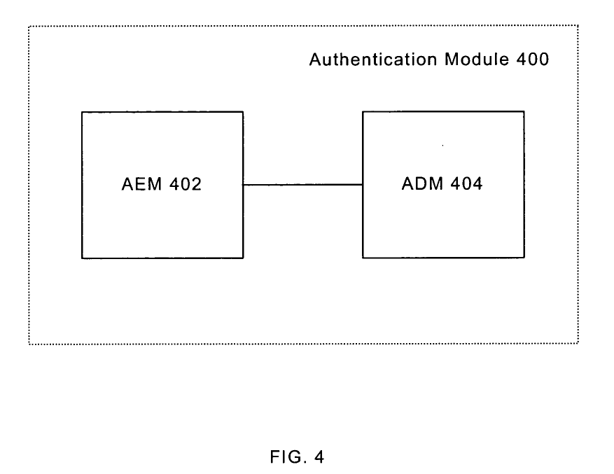

In one embodiment, frame 300 may be configured to hold authentication information for use in authenticating frame 300. The term “authenticating information” as used herein may refer to any type of information that may be used to determine that a frame is authorized for communication on a network. For example, a frame may be an authorized frame if it originates from a known or predetermined network node, such as a Node B or RNC. The authenticating information may be used to protect UMTS network 100. For example, the authentication information may be used to authenticate all frames communicated by the Iub interface and Iur interface of RNC 200. The authentication information may be stored using, for example, spare extension field 306 of frame 300. The authentication operation may be discussed in more detail with reference to FIGS. 4-6.

FIG. 4 illustrates a block diagram of a system 400 in accordance with one embodiment. System 400 may be an AM representative of, for example, AM 212 and 214. As shown in FIG. 4, AM 200 may comprise an authentication encoding module (AEM) 402 and an authentication decoding module (ADM) 404. Although FIG. 4 shows a limited number of modules, it can be appreciated that any number of modules may be used in AM 400.

In one embodiment, AM 400 may comprise AEM 402. AEM 402 may be configured to encode each frame with authentication information. AEM 402 may generate authentication information for a frame to be transmitted by a network interface. Once AEM 402 generates the authentication information, it may store the authentication information in a spare extension field of the frame, such as spare extension field 306 of frame 300.

AEM 402 may use any number of authentication algorithms to generate the authentication information. In one embodiment, for example, AEM 402 may be configured to implement an authentication algorithm, such as an authentication algorithm defined by the Internet Engineering Task Force (IETF) document titled “The MD5 Message-Digest Algorithm”, Request For Comment (RFC) 1321, April 1992 (“MD5 Specification”); or an authentication algorithm such as defined by the IETF document titled “US Secure Hash Algorithm 1”, RFC 3174, September 2001 (“SHA-1 Specification”). The particular authentication algorithm may vary according to a given implementation. The embodiments are not limited in this context.

In one embodiment, for example, AEM 402 may generate authentication information for a frame using an authentication key, an authentication algorithm, and data contained in the frame. AEM 402 may take as input a message of arbitrary length and produce as output an “authentication digest” or “message digest” of the input. The particular authentication algorithm should make it computationally difficult or infeasible to produce two messages having the same message digest, or to produce any message having a given predetermined target message digest.

In one embodiment, AEM 402 may be configured to generate authentication information that is capable of defeating security threats using captured frames. For example, a hacker may tap into a communication link between network nodes to intercept and capture authorized frames. The hacker may attempt to modify or replicate the authorized frames to breach network security. AEM 402 may reduce the possibility of such an attempt being successful by using an additional change parameter to create authentication information for a frame. For example, the change parameter may comprise a count value derived using the connection frame number (CFN). Since the count value constantly changes for each frame, the authentication information for a captured frame may not be properly authenticated since the message digest depends on a parameter which changes between every two subsequent frames. This may create a message digest that is different even for frames with identical data but sent at different time intervals.

In one embodiment, AM 400 may comprise ADM 404. ADM 404 may authenticate each frame using the authentic information retrieved from spare extension field 306 of frame 300. For example, ADM 404 may retrieve an authentication key. ADM 404 may duplicate the authentication information using the authentication key, data from frame 300, and the same hashing algorithm used by the transmitting device. ADM 404 may retrieve the authentication information from frame 300, and compare the duplicated authentication information with the retrieved authentication information. Frame 300 may be authenticated in accordance with the results of the comparison.

In general operation, AM 400 may receive frames of information via Iub line card 206 or Iur line card 208. If a frame such as frame 300 is to be transmitted from RNC 200, AEM 402 may encode spare extension field 306 of frame 300 with the appropriate authentication information. The authentication information may be encoded for frame 300 at any time during the frame processing operations, although it may be advantageous to encode the authentication information once frame 300 has been fully formed and is ready for transmit. If a frame such as frame 300 is received by RNC 200, AM 400 may authenticate the frame to determine whether the RNC 200 should perform any further processing operations for frame 300. ADM 404 may use the data from the frame the same authentication key to calculate the message digest, and compare it with the one received in spare extension field 306 of frame 300. If the authentication check fails (e.g., the message digests are different), frame 300 may be deemed dangerous and should not be further processed.

In one embodiment, RNC 200 may be communicating with several different network nodes using different authentication keys. In this case, the correct authentication key may be inferred from the transport channel on which the frame has been received. Alternate techniques may also be used, however, such as using a single authentication key for entire UMTS network 100. The embodiments are not limited in this context.

It may be possible that some network nodes that are part of UMTS network 100 are not configured to authenticate a frame such as frame 300 using AM 400. In this case, such a network node may ignore the authentication information since spare extension field 306 of frame 300 is an optional field. The network node may therefore process the frame per normal operations.

Operations for the above systems may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

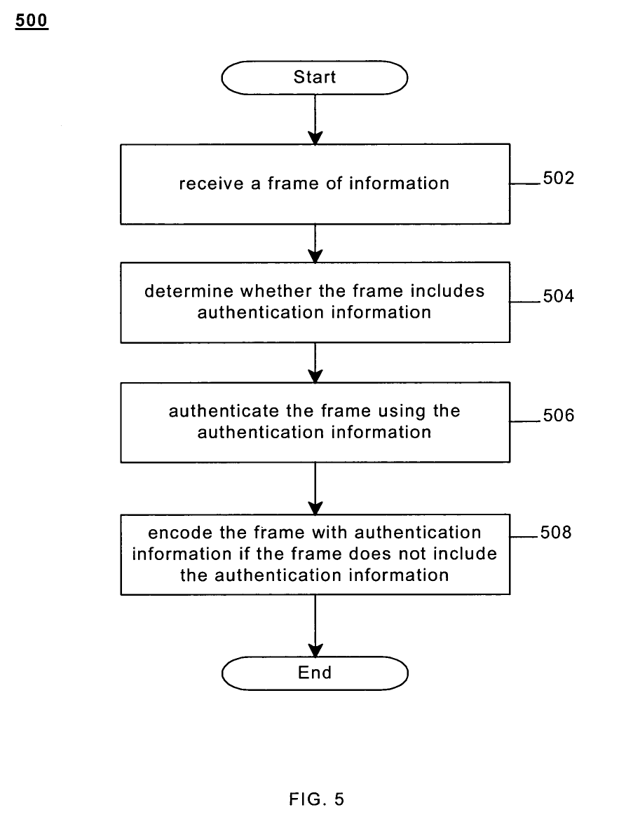

FIG. 5 illustrates a block flow diagram for a programming logic 500 in accordance with one embodiment. FIG. 5 illustrates a programming logic 500 that may be representative of, for example, the operations executed by authentication module 400. As shown in programming logic 500, a frame of information may be received at block 502. A determination may be made as to whether the frame includes authentication information at block 504. If the frame is a frame received from another network device, the frame may be authenticated using the authentication information at block 506. If the frame is a frame to be transmitted to a different device, the frame may be encoded with authentication information at block 508.

In one embodiment, the frame may be authenticated using the authentication information. An authentication key may be retrieved. The authentication information may be duplicated using the authentication key. The authentication information in the frame may be retrieved. The duplicated authentication information may be compared with the retrieved authentication information. The frame may be authenticated in accordance with the results of the comparison.

In one embodiment, the frame may be encoded with authentication information. Authentication information for a frame may be generated. The authentication information may be generated by retrieving an authentication key, data from the frame, and a change parameter. The authentication information may then be created in accordance with an authentication algorithm using the authentication key, the data, and the change parameter. The authentication information may be stored in a spare extension field of the frame.

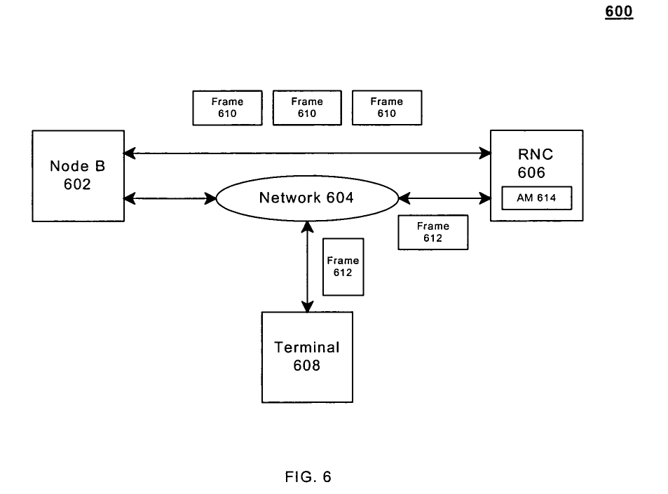

FIG. 6 illustrates a block diagram for a system 600 in accordance with one embodiment. FIG. 6 may be used to further illustrate the operation of the above described systems and associated programming logic by way of example. As shown in FIG. 6, a node B system 602 may communicate authorized frames 610 to RNC 606 via network 608. Network 608 may comprise, for example, an Asynchronous Transport Mode (ATM) network. A terminal 608 may also be connected to network 604. Terminal 608 may be configured to send unauthorized frames 612 to RNC 606 via network 604. The unauthorized frames 612 may comprise, for example, replicates of frames 610, or captured frames 610 that have been modified or resent at a different time. Unauthorized frames 612 may be part of a denial-of-service attack on the Iub interface of RNC 606. A denial-of-service attack may attempt to send large bursts of timing adjustment FP frames to paralyze or shut-down RNC 606. AM 614 of RNC 606 may be used to authenticate each frame received by the Iub interface of RNC 606, and may drop the frames that fail the authentication operation. Consequently, AM 614 may reduce the impact of the denial-of-service attack on RNC 606.

Portions of the embodiments may be implemented using an architecture that may vary in accordance with any number of factors, such as desired computational rate, power levels, heat tolerances, processing cycle budget, input data rates, output data rates, memory resources, data bus speeds and other performance constraints. For example, a portion of one embodiment may be implemented using software executed by a processor, as described previously. In another example, one embodiment may be implemented as dedicated hardware, such as an ASIC, Programmable Logic Device (PLD) or DSP and accompanying hardware structures. In yet another example, one embodiment may be implemented by any combination of programmed general-purpose computer components and custom hardware components. The embodiments are not limited in this context.

The embodiments may have been described in terms of one or more modules. Although an embodiment has been described in terms of “modules” to facilitate description, one or more circuits, components, registers, processors, software subroutines, or any combination thereof could be substituted for one, several, or all of the modules. The embodiments are not limited in this context.

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. An apparatus, comprising:
a network interface to communicate frames of information in accordance with a wireless protocol; and
a frame authentication module operatively responsive to said network interface, said frame authentication module to authenticate frames communicated by said network interface.

2. The apparatus of claim 1, wherein said network interface comprises a network interface defined in accordance with the Universal Mobile Telecommunication System Specification.

3. The apparatus of claim 1, wherein said network interface comprises a network interface configured in accordance with one of an Iub Specification and an Iur Specification.

4. The apparatus of claim 1, wherein said wireless protocol comprises a framing protocol defined by one of an Iub Specification and an Iur Specification.

5. The apparatus of claim 1, wherein said authentication module comprises:
an authentication encoding module to encode each frame with authentication information; and
an authentication decoding module to authenticate each frame using said authentication information.

6. The apparatus of claim 4, wherein said authentication encoding module generates said authentication information using an authentication key, data from said frame, and a change parameter.

7. A system, comprising:
a node B system having a first network interface;
a first radio network controller to communicate with said node B system, said first radio network controller having a second network interface; and
a frame authentication module for each of said first and second network interfaces, said frame authentication module to authenticate frames communicated between said first and second interfaces.

8. The system of claim 7, wherein said network interfaces each comprise network interfaces defined in accordance with the Universal Mobile Telecommunication System Specification.

9. The system of claim 7, wherein said network interface comprises a network interface configured in accordance with one of an Iub Specification and an Iur Specification.

10. The system of claim 7, wherein each frame authentication module comprises:
an authentication encoding module to encode each frame with authentication information; and
an authentication decoding module to authenticate each frame using said authentication information.

11. The system of claim 10, wherein said authentication encoding module generates said authentication information using an authentication key, data from said frame, and a change parameter.

12. The system of claim 7, further comprising:
a second radio network controller to communicate with said first radio network controller, said second radio network controller having a third network interface; and
a frame authentication module for said third network interface, said frame authentication module to authenticate frames communicated between said second and third interfaces.

13. A method, comprising:
receiving a frame of information over a wireless medium;
determining whether said frame includes authentication information;
authenticating said frame using said authentication information; and
encoding said frame with authentication information if said frame does not include said authentication information.

14. The method of claim 13, wherein said authenticating comprises:
retrieving an authentication key;
duplicating said authentication information using said authentication key;
retrieving said authentication information from said frame;
comparing said duplicated authentication information with said retrieved authentication information; and
authenticating said frame in accordance with said comparison.

15. The method of claim 13, wherein said encoding comprises:
generating said authentication information; and
storing said authentication information in a spare extension field of said frame.

16. The method of claim 15, wherein said generating comprises:
retrieving an authentication key;
retrieving data from said frame;
retrieving a change parameter; and
creating said authentication information in accordance with an authentication algorithm using said authentication key, said data, and said change parameter.

17. An article comprising:
a storage medium;
said storage medium including stored instructions that, when executed by a processor, result in receiving a frame of information over a wireless medium, determining whether said frame includes authentication information, authenticating said frame using said authentication information, and encoding said frame with authentication information if said frame does not include said authentication information.

18. The article of claim 17, wherein the stored instructions, when executed by a processor, further result in said authenticating by retrieving an authentication key, duplicating said authentication information using said authentication key, retrieving said authentication information from said frame, comparing said duplicated authentication information with said retrieved authentication information, and authenticating said frame in accordance with said comparison.

19. The article of claim 17, wherein the stored instructions, when executed by a processor, further result in said encoding by generating said authentication information, and storing said authentication information in a spare extension field of said frame.

20. The article of claim 19, wherein the stored instructions, when executed by a processor, further result in said generating by retrieving an authentication key, retrieving data from said frame, retrieving a change parameter, and creating said authentication information in accordance with an authentication algorithm using said authentication key, data, and change parameter.
